(19) United States
(12) Patent Application Publication
(10) Pub. No.: US 2020/0180578 A1
(43) Pub. Date: Jun. 11, 2020

(54) BRAKE CONTROL APPARATUS FOR VEHICLE

(71) Applicant: Toyota Jidosha Kabushiki Kaisha, Toyota-shi Aichi-ken (JP)

(72) Inventor: Ryochi Watanabe, Susono-shi (JP)

(21) Appl. No.: 16/707,397

(22) Filed: Dec. 9, 2019

(30) Foreign Application Priority Data
Dec. 10, 2018 (JP) 2018-230967

(51) Int. Cl. B60T 8/24; B60T 7/12

(52) U.S. Cl. CPC B60T 8/245; B60T 2210/20; B60T 2201/06; B60T 7/122

(57) ABSTRACT

A brake control apparatus for a vehicle performs hill hold control to activate a brake apparatus, without requiring any braking operation of a driver, to thereby prevent the vehicle from moving backward on an uphill, when the uphill on which the vehicle has stopped has an inclination greater than a brake activation threshold. The apparatus detects a structure around the vehicle. In addition, the apparatus changes an execution condition of the hill hold control such that when the structure is detected around the vehicle, the hill hold control is more easily to be started to be performed as compared with a case where the structure is not detected.

### CROSS-REFERENCE: TO RELATED APPLICATION

This application claims priority to Japanese Patent Application No. 2018-230967, filed Dec. 10, 2018, which is hereby incorporated by reference in its entirety including the drawings.

### TECHNICAL FIELD

The present disclosure relates to a brake control apparatus which performs hill hold control for preventing backward movement of a vehicle which has been stopped on an uphill.

### BACKGROUND

A conventionally known brake control apparatus for a vehicle prevents the vehicle which has been stopped on an uphill from moving backward by performing hill hold control which activates the vehicle's brake without requiring a driver's brake operation (see, for example, Japanese Patent Application Laid-Open (kokai) No. H7-69102). Such hill hold control is performed in a case where there is a possibility that the vehicle may move backward on the uphill due to the inclination of the uphill.

For example, when the vehicle stops on the uphill, the brake control apparatus detects the inclination of the uphill and performs the hill hold control if the detected inclination is greater than a brake activation threshold. As a result, backward movement of the vehicle on the uphill is prevented.

### SUMMARY

However, the driver may sense the inclination of the uphill differently depending on the surrounding scenery. For example, in a case where a structure such as a building is present near (around) the driver, the driver senses the degree of inclination of the uphill while using, as references for determining (estimating) the degree of inclination, lines of the structure in the vertical direction and lines thereof in the horizontal direction.

Meanwhile, in a case where no structure is present near (around) the driver, because of a smaller number of elements serving as the references which allow the driver to sense the inclination of the uphill, the driver tends to sense (determine) the inclination of the uphill to a lesser extent. Therefore, in a case where a structure is present near (around) the vehicle, the driver may feel that the uphill has a larger inclination as compared with a case where no structure is present near (around) the vehicle.

The conventional apparatus determines whether to perform the hill hold control based on the inclination detected by a sensor, irrespective of the sense of the driver about the inclination. Therefore, the driver may feel that the hill hold control is performed appropriately in some cases, and may feel that the hill hold control is not performed appropriately in other cases, depending on whether or not a structure is present near (around) the driver. That is, the driver feels the result of the hill hold control differently depending on the scenery around the vehicle, even though the hill hold control is performed on an uphill having a particular (same) inclination. Accordingly, the conventional brake control apparatus may sometimes cause the driver to feel strangeness regarding the hill hold control.

For example, in a case where no structure is present around the vehicle, the driver may feel that the hill hold control is performed too often (the hill hold control is performed even when the driver feels the inclination is small).

The present disclosure has been accomplished so as to solve the above-described problem. One object of the present disclosure is to mitigate a sense of strangeness given to a driver upon performance of the hill hold control.

In order to achieve the above-described object, the present disclosure provides a brake control apparatus for a vehicle (hereinafter may be referred to as the “vehicular brake control apparatus”) which comprises a hill hold control section for performing hill hold control, when an execution condition of the hill hold control is satisfied, the execution condition being a condition to be satisfied when an uphill on which the vehicle has stopped has an inclination greater than a brake activation threshold, the hill hold control being a control to activate a brake apparatus, without requiring any braking operation of a driver, to thereby prevent the vehicle from moving backward on the uphill.

The vehicular brake control apparatus further comprises:

a structure detection section for detecting a structure around the vehicle; and

an execution condition changing section for changing the execution condition of the hill hold control such that the hill hold control is more easily to be started in a case where the structure is detected around the vehicle as compared with a case where the structure is not detected.

The vehicular brake control apparatus of the present disclosure comprises the hill hold control section. The hill hold control section performs, when an uphill on which the vehicle has stopped has an inclination greater than the brake activation threshold, the hill hold control for activating the brake apparatus, without requiring any braking operation of the drive, thereby preventing the vehicle from moving backward on the uphill. Namely, the execution condition of the hill hold control includes a condition which is satisfied when the uphill has an inclination greater than the brake activation threshold (in other words, when the degree of the inclination of the uphill is greater than the brake activation threshold).

The vehicular brake control apparatus further comprises the structure detection section and the execution condition changing section. The structure detection section detects a structure around the vehicle. For example, the structure detection section photographs (takes a picture of) an area around the vehicle and detects a structure (for example, a building) by extracting an image of the structure from a camera image obtained through the photographing.

In a case where a structure such as a building is present near (around) the driver, the driver senses the degree of inclination of the uphill while using the structure as references for sensing the vertical and horizontal directions. Meanwhile, in a case where no structure is present near (around) the driver, because there is little element in the scenery serving as the references that the driver can use to sense the inclination of the uphill the driver may sense the inclination of the uphill to a lesser extent (in other words, the driver tends to determine that the inclination of the uphill is smaller than the actual inclination). Therefore, in a case where a structure is present near (around) the driver, the driver feels that the uphill has a larger inclination as compared with a case where no structure is present near (around) the driver.

Accordingly, if the hill hold control is always started to be performed when a fixed certain execution condition is satisfied, the driver may feel that the hill hold control is started to be performed appropriately in some cases, whereas the driver feels that the hill hold control is not started to be performed appropriately in other cases. In order to solve the above problem, the execution condition changing section changes the execution condition of the hill hold control such that when a structure is detected near (around) the vehicle, the hill hold control is more easily to be started (or is likely to be started) to be performed (namely, the hill hold control is started to be performed even when the inclination is relatively small) as compared with a case where no structure is detected. Consequently, since the hill hold control can be performed in accordance with the degree of inclination of the uphill that the driver senses, the strange feeling of the driver can be mitigated (reduced).

In one aspect of the present disclosure, the execution condition changing section is configured to change the execution condition of the hill hold control such that the hill hold control is more easily to be started when the structure detected around the vehicle is located near the vehicle, as compared with when the structure is located away from the vehicle.

In a case where a structure is present near (around) the driver, the shorter a distance between the structure and the vehicle is, the greater the inclination of the uphill as sensed by the driver is. In view of this, the execution condition changing section changes the execution condition of the hill hold control such that the hill hold control is more easily to be started to be performed when the structure detected around the vehicle is located near the vehicle, as compared with when the structure is located away from the vehicle. Consequently, since the hill hold control can be performed in accordance with the degree of inclination of the uphill that the driver senses, the strange feeling of the driver can be mitigated (reduced).

In another aspect of the present disclosure, the execution condition changing section is configured to decrease the brake activation threshold to let the hill hold control be started more easily.

The hill hold control is performed when the uphill on which the vehicle has stopped has an inclination greater than the brake activation threshold. In view of this, the execution condition changing section decreases the brake activation threshold (so as to change the execution condition of the hill hold control) such that the hill hold control can be started (performed) even when the inclination of the uphill is small. In this manner, the execution condition of the hill hold control can be changed appropriately.

In still another aspect of the present disclosure,

the structure detection section is configured to recognize the structure on the basis of a camera image obtained by photographing an area ahead of the vehicle using a camera, and

the execution condition changing section is configured to:
extract, from the camera image, a vertical image element vertically extending and a horizontal image element horizontally extending, the vertical image element and the horizontal image element corresponding to an image of a structure in the camera image;
calculate a structure index value in such a manner that the structure index value increases as a ratio increases, the ratio being a ratio of the vertical image element and the horizontal image element to the camera image; and
determine the brake activation threshold on the basis of the structure index value.

In a case where a structure such as a building is present near (around) the driver, the driver senses the degree of inclination of the uphill, while using, as references, a vertically extending line(s) and a horizontally extending line(s) formed in the structure. In such a case, the larger the number (or the total length) of the vertically extending line(s) and the horizontally extending line(s) visually recognized in the structure is, the greater the inclination of the uphill that the driver senses is.

In view of this, in the present aspect of the present disclosure, the structure detection section recognizes the structure on the basis of the camera image obtained by photographing an area ahead of the vehicle using the camera. The execution condition changing section extracts a vertically extending vertical image element and a horizontally extending horizontal image element of the structure in the camera image. In addition, the execution condition changing section calculates the structure index value which increases as the ratio increases, the ratio being a ratio of the vertical image element and the horizontal image element to the camera image. Further, the execution condition changing section determines the brake activation threshold on the basis of the structure index value.

For example, the vertical image element is an image part which constitutes a vertically extending line detected in the structure on the camera image, and the horizontal image element lis an image part which constitutes a horizontally extending line detected in the structure on the camera image.

Therefore, in the present aspect of the present disclosure, the degree of inclination of the uphill that the driver senses can be estimated (deduced) from the structure index value. As a result, the hill hold control can be performed in accordance with the degree of inclination of the uphill that the driver senses. Therefore, the strange feeling of the driver can be mitigated.

In addition, in the present aspect, the execution condition changing section may be configured to
determine whether or not the structure index value is greater than a previously set structure index threshold; and
set the brake activation threshold, when the structure index value is greater than the structure index threshold, to a value which is smaller than a value set when the structure index value is equal to or smaller than the structure index threshold.

In this aspect of the present disclosure, when the structure index value is greater than the structure index threshold, the execution condition -hanging section sets the brake activation threshold to a value which is smaller than a value to which the execution condition changing section sets the brake activation threshold when the structure index value is equal to or smaller than the structure index threshold. The greater the structure index value is, the greater the degree of inclination of the uphill that the driver senses is. Accordingly, in this aspect of the present disclosure, the hill hold control can be performed in accordance with the degree of inclination of the uphill that the driver senses. Therefore, the strange feeling of the driver can be mitigated.

Further, in the present aspect, the execution condition changing section may be configured to:
calculate the structure index value in a region located close to the uphill and the structure index value in a region located away from the uphill; and
set the brake activation threshold, when the structure index value in the region located close to the uphill is greater than the structure index value in the region located away from the uphill, to a value which is smaller than a value set when the structure index value in the region located close to the uphill is smaller than the structure index value in the region located away from the uphill.

The shorter the distance from the driver to the structure is, the greater the degree of inclination of the uphill that the driver senses is. In view of this, in this aspect of the present disclosure, the execution condition changing section calculates the structure index value in/for a region located close to the uphill and the structure index value in/for a region located away from the uphill. In addition, when the structure index value in the region located close to the uphill is greater than the structure index value in the region located away from the uphill, the execution condition changing section sets the brake activation threshold to a value which is smaller than a value to which the execution condition changing section sets the brake activation threshold when the structure index value in the region located close to the uphill is smaller than the structure index value in the region located away from the uphill. Accordingly, in this aspect of the present disclosure, the hill hold control can be performed in accordance with the degree of inclination of the uphill that the driver senses. Therefore, the strange feeling of the driver can be mitigated.

Notably, objects, other features, and attendant advantages of the present disclosure will be readily appreciated horn the following description of the embodiment of the disclosure which is made with reference to the accompanying drawings.

### BRIEF DESCRIPTION OF THE DRAWINGS

FIG. 1 is a schematic diagram of a vehicle (own vehicle) on which a brake control apparatus for a vehicle (present apparatus) is installed;

FIG. 2 is a flowchart representing a hill hold control routine executed by the present apparatus;

FIG. 3 is a flowchart representing a brake activation threshold calculation routine (subroutine) executed by the present apparatus;

FIG. 4 is an example of divided regions of a front camera image which includes structures;

FIG. 5 is another example of divided regions of the front camera image which includes no structure;

FIG. 6 is a flowchart representing a brake activation threshold calculation routine (subroutine) executed by the present apparatus according to a modification;

FIG. 7 is an example according to the modification of divided regions of the front camera image which includes structures located near the own vehicle; and

FIG. 8 is another example according to the modification of divided regions of the front camera image which includes a structure located away from the own vehicle;

### DETAILED DESCRIPTION

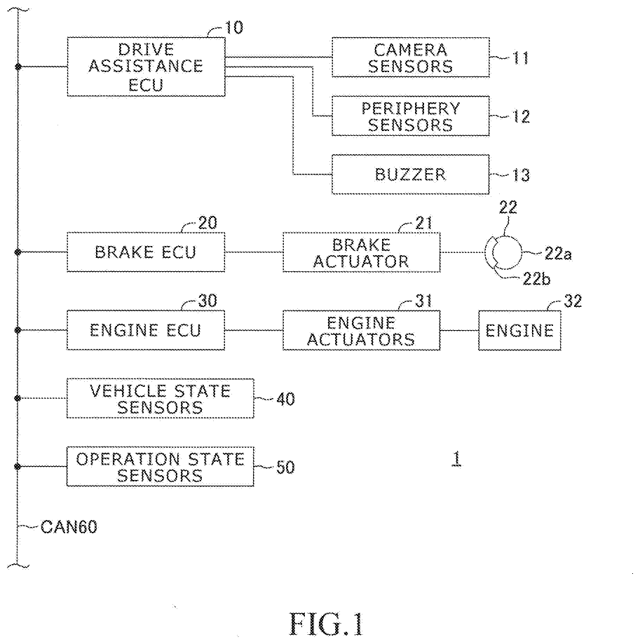

An embodiment of the present disclosure will next be described with reference to the drawings. FIG. 1 is a schematic diagram of a drive support system 1 equipped with a brake control apparatus for a vehicle according to the present embodiment.

The drive support system 1 is installed (mounted) on a vehicle (hereinafter, also referred to as an “own vehicle” in order to distinguish the own vehicle from other vehicles). The drive support system 1 includes a drive assistance ECU 10, a brake ECU 20, and an engine ECU 30 as shown in FIG.

Each of the ECUs is an Electric Control Unit which includes a microcomputer as a main component. These ECUs are connected to each other via a Controller Area Network (CAN) 60 so as to send information to the other ECUs and receive information from the other ECUs. In the present embodiment, each of the microcomputers includes a CPU, a ROM, a RAM, a non-volatile memory, interfaces (I/F), and the like. The CPU is configured to implement various functions by executing instructions (programs, routines) stored in the ROM. Some or all of those ECUs may be integrated into a (one) single ECU.

Various vehicle state sensors 40 which detect states of the own vehicle, and various operation state sensors 50 which detect drive operation states are connected to the CAN 60. The vehicle state sensors 40 include a vehicle speed sensor for detecting a vehicle speed (travelling speed) of the own vehicle, a longitudinal acceleration sensor for detecting an acceleration of the own vehicle in the longitudinal direction, a lateral acceleration sensor for detecting an acceleration of the own vehicle in the lateral direction, a yaw rate sensor for detecting a yaw rate of the own vehicle. It should be noted that the longitudinal acceleration sensor is also utilized as an inclination sensor for detecting a climbing angle (or an inclination) of a road surface.

The operation state sensors 50 include an accelerator operation amount sensor for detecting an operation amount of an accelerator pedal, a brake operation amount sensor for detecting an operation amount of a brake pedal, a brake switch for detecting the presence of an operation of the brake pedal, a steering angle sensor for detecting a steering angle of a steering wheel, a steering torque sensor for detecting a steering torque of the steering wheel steered by a driver of the own vehicle, a shift position sensor for detecting a shift (operation) position of a shift lever.

Information detected (acquired) by the vehicle state sensors 40 and the operation state sensors 50 (hereinafter also referred to as “sensor information” for simplification) is sent to (via) the CAN 60 so as to be received and be utilized by the ECUs as needed. Notably, some of the sensors may be connected to a certain ECU and, in this case, information detected by those sensors is sent to (via) the CAN 60 by the certain ECU as the sensor information. For example, the accelerator operation amount sensor may be connected to the engine ECU 30 and, in this case, the engine ECU 30 sends the operation amount of the accelerator pedal to (via) the CAN 60. Further, a configuration where sensor information is mutually exchanged between the ECUs directly without the CAN 60 may be adopted.

The drive assistance ECU 10 is a main control apparatus (controller, control unit) for providing drive support to the driver and connected to camera sensors 11, periphery sensors 12, and a buzzer 13.

The camera sensors 11 include a front camera and a rear camera which are not shown. The front camera is mounted on a front center part of a vehicle body of the own vehicle and photographs (takes a picture of) a frontward region of the own vehicle. The rear camera is mounted on a rear center part of the vehicle body and photographs (takes a picture of) a backward region of the own vehicle, image data representing a picture obtained by photographing the frontward region, and image data representing a picture obtained by photographing the backward region are respectively sent to the drive assistance ECU 10.

The drive assistance ECU 10 includes an image processing section which is not shown. The drive assistance ECU 10 recognizes a tridimensional object (for example, another vehicle, a pedestrian, a bicycle, a structure (structural object, construction), or the like) and white lines (i.e., lane markers) on a road surface through the image processing section.

The periphery sensors 12 include a plurality of radar sensors (not shown) whose detection regions are different from each other. Each of the radar sensors includes a radar transmission-reception section and a signal processing section. The radar transmission-reception section transmits a radio wave in a millimeter wave band (hereinafter also referred to as a “millimeter wave”) which propagates within a detection area and receives a reflected millimeter wave which is a reflected wave generated by a tridimensional object within the detection area. The signal processing section obtains information (hereinafter also referred to as “periphery information”) which is indicative of the distance between the own vehicle and the tridimensional object, the relative speed of the tridimensional object with respect to the own vehicle, the relative position (direction) of the tridimensional object with respect to the own vehicle, or the like, every time a predetermined time elapses on the basis of the phase difference between the transmitted millimeter wave and the reflected millimeter wave, the attenuation quantity of the reflected millimeter wave, the time difference between the of transmission of the millimeter wave and the reception of the reflected millimeter wave. The signal processing section transmits the obtained periphery information to the drive assistance ECU 10.

In the present embodiment, the periphery sensors 12 are the radar sensors, however, other sensors than the radar sensors such as a lidar sensor may be adopted.

The brake ECU 20 is connected to a brake actuator 21. The brake actuator 21 is provided in a hydraulic circuit communicating between a master cylinder (not shown) and frictional brake mechanisms 22. The master cylinder pressurizes hydraulic oil by using the depressing force applied to the brake pedal. Each of the frictional brake mechanisms 22 is disposed in each of four wheels (a front-right, a front-left, a rear-right, and a rear-left wheels of the own vehicle). The frictional brake mechanism 22 includes a brake disk 22a fixed to the respective wheel, and a brake caliper 22b fixed to the vehicle body. The brake actuator 21 controls oil pressure supplied to wheel cylinders each of which is built in the brake caliper 22b in response to a request from the brake ECU 20 so as to operate the wheel cylinders to push brake pads each of which is also built in the brake caliper 22b against the brake disks 22a. Thus, frictional brake force applied to each of the wheels is generated. Therefore, the brake ECU 20 can control decelerating state (namely, the deceleration) of the own vehicle and keep the own vehicle in stopped state by controlling the frictional brake force applied to the wheels without requiring any braking operation of the driver. The brake actuator 21 and the frictional brake mechanism 22 correspond to “brake apparatus” of the present disclosure.

The engine ECU 30 is connected to engine actuators 3 which are used for controlling operational condition of an internal combustion engine 32. The internal combustion engine 32 is also referred to as “the engine 32” for simplification, in the present embodiment, the engine 32 is a multi-cylinder, gasoline fuel injection type, spark ignition engine having a throttle valve for adjusting intake air amount. The engine actuators 31 include a throttle valve actuator for controlling an opening degree of the throttle valve. The engine ECU 30 can control a torque which the engine 32 generates by controlling the engine actuators 31. The torque generated by the engine 32 is transmitted to drive wheels via transmission gears (both are not shown). Therefore, the engine ECU 30 can control drive force of the own vehicle so as to control accelerating state (namely, the acceleration) of the own vehicle by controlling the engine actuators 31.

The drive assistance ECU 10 executes well-known drive assist control on the basis of the image data sent by the camera sensors 11, the periphery information sent by the periphery sensors 12, the sensor information sent by the vehicle state sensors 40, and the sensor information sent by the operation state sensors 50. For example, the drive assistance ECU 10 executes a pre-crush safety control, a radar cruise control, and the like. The pre-crush safety control is executed for assisting collision avoidance operation of the driver by an alert and control of brake force when an obstacle is detected in front of the own vehicle. The radar cruise control is executed for assisting operation to the accelerator pedal by the driver so as to control drive force such that the own vehicle follows a “following target vehicle” in accordance with speed change of the following target vehicle.

When the drive assistance ECU 10 executes such kind of drive assist control, the drive assistance ECU 10 sends a control request to the brake ECU 20 or the engine ECU 30 so as to control travelling condition of the own vehicle.

In addition, the drive assistance ECU 10 executes hill hold control as a kind of drive assist control. The hill hold control is executed in a case where the own vehicle stops on a slope, in order to keep the own vehicle in stopping condition by activating the brake apparatus even when the brake pedal is not operated by the driver. It should be noted that, whereas the hill hold control described below is executed when the own vehicle stops on an uphill (upslope), a conventionally known control may be executed when the own vehicle stops on a downhill (downslope).

### <Hill Hold Control>

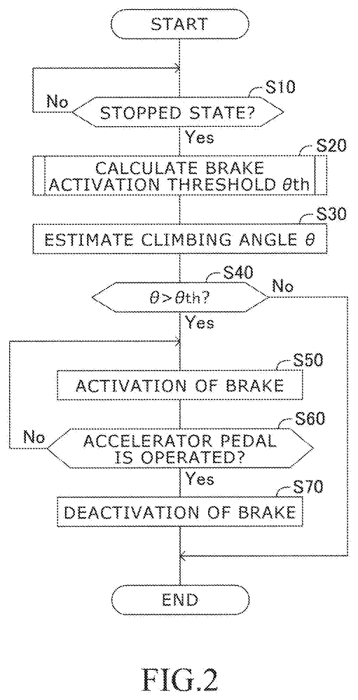

A flowchart in FIG. 2 represents a hill hold control routine executed by the drive assistance ECU 10.

When an appropriate timing has come, the drive assistance ECU 10 starts processing of the hill hold control routine and proceeds to step S10 so as to determine whether or not the own vehicle stops travelling (running). For example, the drive assistance ECU 10 determines, on the basis of the vehicle speed detected by the vehicle speed sensor and the sensor information from the operation state sensors 50 (specifically, the brake operation amount sensor or the brake switch), whether or not the travelling condition of the own vehicle is changed from a travelling state to a stopped state due to the operation of the driver to the brake pedal.

The drive assistance ECU 10 executes the determination processing of step S10 every time a predetermined calculation interval elapses, while the determination condition of step S10 is not satisfied. When the drive assistance ECU 10 determines that the own vehicle stops travelling, the drive assistance ECU 10 proceeds to step S20 so as to calculate (figure out) a brake activation threshold θth. This calculation processing of the brake activation threshold θth will be specifically described later.

Subsequently, the drive assistance ECU 10 proceeds to step S30 so as to estimate a climbing angle θ of a road surface on which the own vehicle has stopped. The climbing angle θ of the road surface is equal to an inclination angle in the longitudinal direction of the own vehicle. The drive assistance ECU 10 estimates the climbing angle θ on the basis of the acceleration of the own vehicle in the longitudinal direction detected by the longitudinal acceleration sensor which is included in the vehicle state sensors 40. In a case where the own vehicle is on a slope in the longitudinal direction, the longitudinal acceleration sensor detects a value according to the component of the downward slope of the gravity, since the gravity in the longitudinal direction of the own vehicle, acts even when the own vehicle is not in an accelerated motion in the longitudinal direction. For example, a relational expression of Gx=G×sin θ is satisfied wherein the climbing angle (elevation angle) is θ, an acceleration to backward detected by the longitudinal acceleration sensor is Gx, and the acceleration of the gravity is G. Therefore, it is possible to figure out the climbing angle θ(=sin⁻¹(Gx/G)) on the basis of the relational expression (when the own vehicle is not moving).

Subsequently, the drive assistance ECU 10 proceeds to step S40 so as to determine whether or not the climbing angle θ is greater than the brake activation threshold θth. If the climbing angle θ is equal to or less than the brake activation threshold θth (S40: No), the drive assistance ECU 10 ends the hill hold control routine temporarily. In this case, after a predetermined calculation interval elapses, the drive assistance ECU 10 starts processing of the hill hold control routine again. Therefore, when the own vehicle stops travelling next time, a determination result of step S10 becomes “Yes” and the following processes including step S20 is executed.

In contrast, if the climbing angle θ is greater than the brake activation threshold θth (S40: Yes), the drive assistance ECU 10 proceeds to step S50 so as to send a “brake request for hill hold” to the brake ECU 20. When the brake ECU 20 receives the brake request for hill hold, the brake ECU 20 controls the brake actuator 21 such that the each of the oil pressures supplied to the wheel cylinders of the four wheels becomes a predetermined pressure for hill hold. Consequently, brake force on each of the four wheels is generated respectively. As a result, the own vehicle is kept stopping (does not move) even if the driver does not operate the brake pedal (i.e., releases the brake pedal). Notably, the pressure for hill hold may be a fixed value. Alternatively, the pressure for hill hold may be a variable value (for example, a value which changes according to the climbing angle θ). In addition, each of the four wheels does not have to be a “hill hold braking wheel” to which brake force is applied when the hill hold control is executed. For example, only the right and left front wheels may be the hill hold braking wheels. Alternatively, only the right and left rear wheels may be the hill hold braking wheels.

Notably, performing the hill hold control of the present disclosure corresponds to executing the process of step S50. Therefore, in the present disclosure, the expression that the hill hold control is made easier to be executed means that the process of step S50 is made easier to be executed. In other words, if the processing of step S50 becomes more likely (easily) to be executed as a result of processing, described later, it represents that the hill hold control becomes more likely (easily) to be performed.

Subsequently, the drive assistance ECU 10 proceeds to step S60 so as to determine whether or not the accelerator pedal has been operated. Specifically, the drive assistance ECU 10 determines whether or not the operation amount of the accelerator pedal (accelerator operation amount) detected by the accelerator operation amount sensor has become greater than a predetermined value (which is “0” in the present embodiment). If the accelerator operation amount is “0” (S60: No), the drive assistance ECU 10 proceeds to step S50 again. Therefore, the brake actuator 21 continues generating brake force while the accelerator pedal is not operated.

Meanwhile, when operation to the accelerator pedal is started (S60: Yes), the drive assistance ECU 10 proceeds to step S70 so as to send a “brake release request for hill hold” to the brake ECU 20. When the brake ECU 20 receives the brake release request for hill hold, the brake ECU 20 controls the brake actuator 21 such that the oil pressures supplied to the wheel cylinders of the four wheels decrease. Consequently, brake force acting on each of the four wheels is released (eliminated). As a result, the own vehicle is allowed to (or comes to be able to) move forward on the uphill.

Notably, when reducing the brake force to zero in the above case, the brake force may be gradually decreased. For example, the oil pressures supplied to the wheel cylinders may be reduced more quickly as an increasing rate of the accelerator operation amount is greater.

Subsequently, the drive assistance ECU 10 ends the hill hold control routine after processing of step S70. In this case, after the calculation interval elapses, the drive assistance ECU 10 starts processing of the hill hold control routine again.

### <Brake Activation Threshold Calculation Routine>

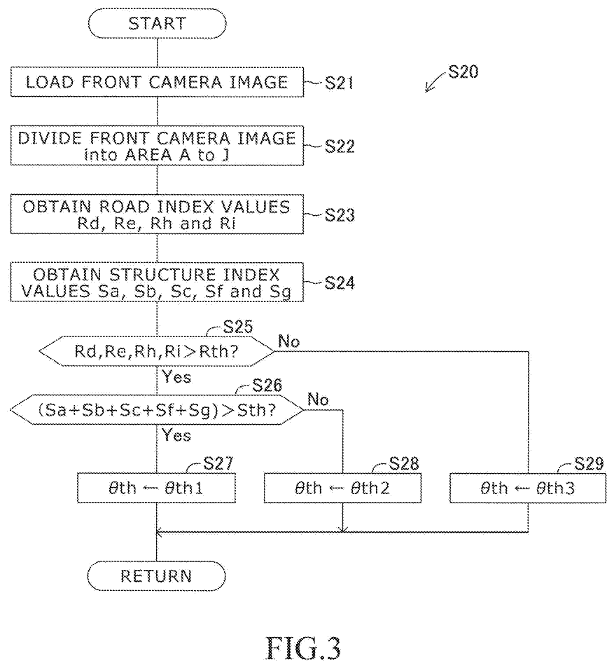

The calculation processing of the brake activation threshold θth will next be described_{—} A flowchart shown in FIG. 3 represents a brake activation threshold calculation routine. When the drive assistance ECU 10 proceeds to step S20, the drive assistance ECU 10 starts the process of the brake activation threshold calculation routine.

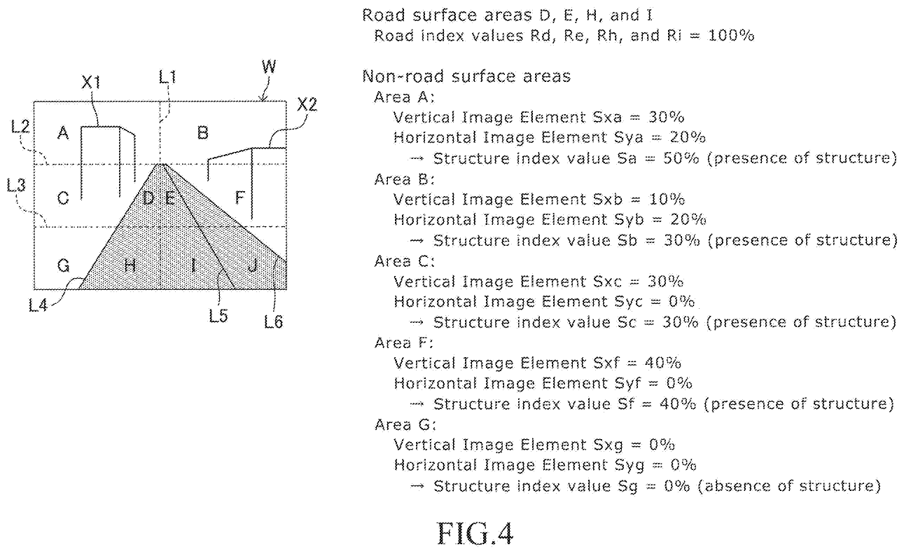

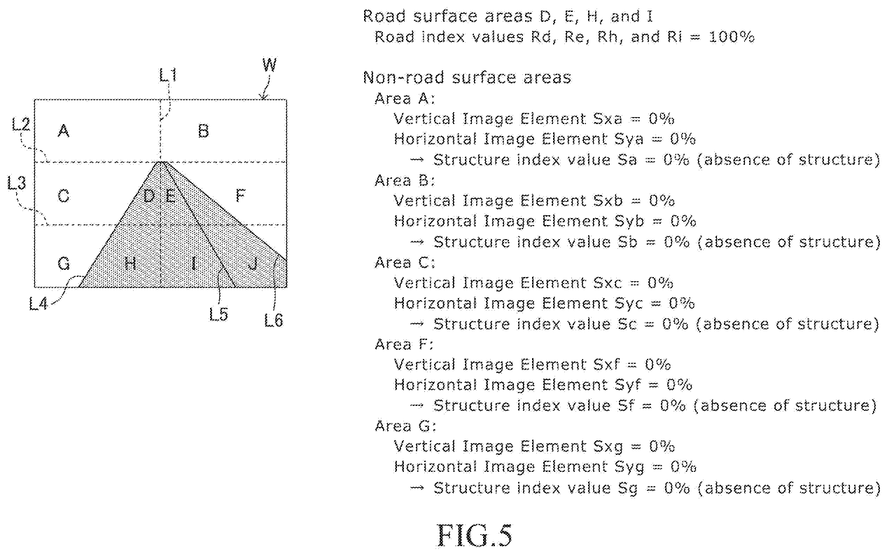

When the drive assistance ECU 10 starts the process of the brake activation threshold calculation routine, the drive assistance ECU 10 proceeds to step S21 so as to load an image referred to as a front camera image W photographed by the front camera of the camera sensors 11. Subsequently, the drive assistance ECU 1 proceeds to step S22 so as to divide the front camera image W into areas from an area A to an area J as shown in FIG. 4 and FIG. 5. More specifically, the front camera image W is equally divided into six areas by a center line L1, a horizontal line L2, and a horizontal line L3. The center line L1 is a straight line extending in the vertical direction passing through the center in the horizontal direction of the front camera image W. The horizontal line L2 and the horizontal line L3 are straight lines extending in the horizontal direction. The front camera image W is further divided by a division line L4, a division line L5, and a division line L6. The division lines L4, L5, and L6 are lines for defining “lane areas” in the front camera image W. The division lines L4, and L5 are predetermined lines that correspond to (or define) one of the lane areas corresponding to a traffic lane (i.e., an own lane) on which the own vehicle is travelling. Namely, the own lane in the front camera image W is an area between the division line L4 and the division line L5. The division line L6 is a predetermined line that corresponds to (or defines together with the division line L5) the other one of the lane areas corresponding to a traffic lane an adjacent lane) which is adjacent to the own lane. Namely, the adjacent lane in the front camera image W is an area between the division line L5 and the division line L6.

Thus, as understood from FIG. 4, the area A is defined (surrounded) by the top and left sides of the front camera image W, the center line L1, and the horizontal line L2. The area B is defined (surrounded) by the top and right sides of the front camera image W, the center line L1, and the horizontal line L2. The area C is defined (surrounded) by the left side of the front camera image W, the horizontal line L2, the horizontal line L3, and the division line L4. The area D is defined (surrounded) by the center line L1, the horizontal line L3, and the division line L4. The area E is defined (surrounded) by the center line L1, the horizontal line L3, and the division line L5. The area F is defined (surrounded) by the horizontal line L2, the division line L6, and the right sides of the front camera image W. The area G is defined (surrounded) by the left and bottom sides of the front camera image W, the horizontal line L3, and the division line L4. The area H is defined (surrounded) by the bottom side of the front camera image W, the center line L1, the horizontal line L3, and the division line L4. The area I is defined (surrounded) by the bottom side of the front camera image W, the center line L1, the horizontal line L3, and the division line L5. The area J is defined (surrounded) by the bottom and right sides of the front camera image W, the division line L5, and the division line L6. Notably, in the present embodiment, the division line L4, the division line L5, and the division line L6 are predetermined lines, however, these division lines may be determined according to the own lane and the adjacent lane which are extracted (recognized) from the front camera image W by executing, a conventionally known image processing.

Subsequently, the drive assistance ECU 10 proceeds to step S23 so as to obtain (calculate) road index values Rd, Re, Rh and Ri corresponding to the areas D, E, H, and I, respectively. The areas D, E, H, and I correspond to a road surface area (own lane area). The road index value of a certain road surface area is designed (defined) to become larger as the reliability of estimating that the certain road surface area corresponds to a paved road surface is higher. Specifically, the drive assistance ECU 10 obtains each of the road index values Rd, Re, Rh and RI on the basis of a feature represented by color, brightness, roughness, or the like of each of the area D, E, H, and respectively. In the present example, the drive assistance ECU 10 obtains the road index value in such a manner that the road index value becomes larger as the feature of the area is closer to a reference feature which was obtained by photographing a typical paved road surface and has been stored in the ROM in advance.

Subsequently, the drive assistance ECU 10 proceeds to step S24 so as to obtain (calculate) structure index values Sa, Sb, Sc, Sf, and Sg corresponding to the areas A, B, C, F, and G, respectively. The areas A, B, C, F, and G correspond to area (i.e., non-road surface areas) other than the road surface area. This structure index value of a certain non-road surface area is designed (defined) to become larger as a possibility that a large structure is present is greater. More specifically, structure index value of a certain non-road surface area is designed (defined) to become larger as the outlines in the vertical and/or horizontal directions of a structure present in a certain non-road surface area are/is longer.

At this time, the drive assistance ECU 10 executes the image processing of the front camera image W so as to recognize a structure in front of the own vehicle and to obtain (calculate) a vertical image element value and a horizontal image element value for each of the areas A, B, C, F, and G. The vertical image element value for a certain area indicates an extent of “outline length of a structure” extending in the vertical direction included in the certain area. The horizontal image element value for a certain area indicates an extent of “outline length of a structure” extending in the horizontal direction included in the certain area. For example, a vertical image element value for a certain area is obtained by dividing “the sum of outline length (vertical outline length) of a structure extending in the vertical direction included in the certain area” by “a predetermined value which is proportional to the square measure (or an area) of the certain area.” Similarly, a horizontal image element value for a certain area is obtained by dividing “the sum of outline length (horizontal outline length) of a structure extending in the horizontal direction included in the certain area” by “a predetermined value which is proportional to the square measure of the certain area.”

In the present embodiment, the vertical image element value and the horizontal image element value are calculated on the basis of the outline of a structure as described above. However, for example, if a line (inside vertical line) extending in the vertical direction is detected inside (of the outline) of a structure, the vertical image element value may be calculated through the above described manner with adding length of the inside vertical line to the sum of vertical outline length. Similarly, if a line (inside horizontal line) extending in the horizontal direction is detected inside (of the outline) of a structure, the horizontal image element value may be calculated through the above described manner with adding length of the inside horizontal line to the sum of horizontal outline length.

In an example of the font camera image W shown in FIG. 4, an image of a structure X1 extends so as to be present in the area A and the area B An image of a structure X2 extends so as to be present in the area B and the area F. Namely, each of the area A and the area C of the front camera image W partially overlaps with the structure X1. In addition, each of the area B and the area F partially overlaps with the structure X2. In the present example, a vertical image element value Sxa for the area A is 30%. A horizontal image element value Sya for the area A is 20%. A vertical image element value Sxb for the area B is 10%. A horizontal image element value Syb for the area B is 20%. A vertical image element value Sxc for the area C is 30%. A horizontal image element value Syc for the area C is 0%. A vertical image element value Sxf for the area F is 40%. A horizontal image element value Syf for the area F is 0%. In addition, both a vertical image element value Sxg and a horizontal image element value Syg for the area G which includes no image of a structure are 0%.

Hereinafter, each of the vertical image element values Sxa, Sxb, Sxc, Sxf, and Sxg, may be collectively referred to as a vertical image element value Sx unless these vertical image element values need to be distinguished from each other. Similarly, each of the horizontal image element values Sys, Syb, Syc, Syf, and Syg may be collectively referred to as a horizontal image element value Sy unless these horizontal image element values need to be distinguished from each other.

In contrast, in another example of the front camera image W shown in FIG. 5, no areas of the front camera image W include an image of a structure. Therefore, each of the vertical image element values Sx and the horizontal image element values Sy for all of the areas A, B, C, F, and C is 0%.

The drive assistance ECU 10 obtains a structure index value for each of the areas. Specifically, the drive assistance ECU 10 obtains, as the structure index value for a certain area, the sum of the vertical image element value Sx and the horizontal image element value Sy of the certain area. Therefore, according to the example of FIG. 4, the structure index value Sa of the area A is 50% which is the sum of the vertical image element value Sxa and the horizontal image element value Sya. The structure index value Sb of the area B is 30% which is the sum of the vertical image element value Sxb and the horizontal image element value Syb. The structure index value Sc of the area C is 30% which is the sum of the vertical image element value Sxc and the horizontal image element value Syc. The structure index value Sf of the area F is 40% which is the sum of the vertical image element value Sxf and the horizontal image element value Syf. The structure index value Sg of the area C is 0% which is the sum of the vertical image element value Sxg and the horizontal image element value Spa.

Subsequently, the drive assistance ECU 10 proceeds to step S25 so as to determine whether or not each of the road index values Rd, Re, Rh and Ri is greater than a predetermined road index threshold value Rth. If each and every one of the road index values Rd, Re, Rh and Ri is greater than the road index threshold value Rth, the drive assistance ECU 10 makes a “Yes” determination in step S25. If at least one of the road index values Rd, Re, Rh and Ri is equal to or smaller than the road index threshold value Rth, the drive assistance ECU 10 makes a “No” determination in step S25. Notably, the drive assistance ECU 10 may be configured to make a “Yes” determination in step S25 if the number of values from among the road index values Rd, Re, Rh and Ri which are greater than the road index threshold value Rth is greater than a predetermined threshold.

If at least one of the road index values Rd, Re, Rh and Ri is equal to or smaller than the road index threshold value Rth, there is a probability that a travelling region in front of the own vehicle is nota road. Therefore, if that happens, the drive assistance ECU 10 makes a No determination in step S25 to proceed to step S29, at which the ECU 10 sets the brake activation threshold θth to a predetermined third activation threshold θth3.

Meanwhile, if each and every one of the road index values Rd, Re, Rh and Ri is greater than the road index threshold value Rth (S25: Yes), the drive assistance ECU 10 proceeds to step S26. Namely, if it can be determined that the travelling region in front of the own vehicle is highly likely to be a road, the drive assistance ECU 10 proceeds to step S26.

In step S26, the drive assistance ECU 10 determines whether or not a total value Ssum is greater than a predetermined structure index threshold value Sth. The total value Ssum is equal to the sum of the structure index values Sa, Sb, Sc, Sf and Se (namely, Ssum=Sa+Sb+Sc+Sf+Sg). The structure index threshold value Sth is a threshold value for determining whether or not there is a structure in front of the own vehicle, the structure serving as references (determination standard) for the driver to estimate (sense) the degree of an inclination of a slope (namely, the climbing angle θ).

If the total value Ssum is greater than the structure index threshold value Sth (namely, it is deduced (determined) that a structure is likely to be present in front of the own vehicle, the structure serving as the references For the driver to estimate the degree of inclination of the slope), the drive assistance ECU 10 proceeds to step S27 so as to set the brake activation threshold θth to a predetermined first activation threshold θth1.

Meanwhile, if the total value Ssum is equal to or smaller than the structure index threshold value Sth (namely, it is deduced (determined) that no structure serving as the references is likely to be present in front of the own vehicle), the drive assistance ECU 10 proceeds to step S28 so as to set the brake activation threshold θth to a predetermined second activation threshold θth2.

The second activation threshold θth2 is greater than the first activation threshold θth1, and the third activation threshold θth3 is greater than the second activation threshold θth2 (namely, θth1<θth2<θth3).

When the drive assistance ECU 10 completes process in step S27, step S28 or step S29, the drive assistance ECU 10 ends the brake activation threshold calculation routine and proceeds to step S30 of FIG. 2.

The reason why the brake activation threshold θth is set to one of the values (namely, one of θth1, θth2, and θth3) as described above through the brake activation threshold calculation routine will next be described.

According to the hill hold control routine described above, when the own vehicle has stopped on an uphill, the drive assistance ECU 10 detects the climbing angle θ by use of a climbing angle sensor (the longitudinal acceleration sensor). In addition, if that climbing angle θ is greater than the brake activation threshold θth, the drive assistance ECU 10 activates the brake actuator 21 to apply the brake force to each of the four wheels (namely, the ECU 10 executes the hill hold control), thereby preventing the own vehicle from moving backward on the uphill, even if the driver does not operate (or releases) the brake pedal.

Meanwhile, the driver may sense the inclination of an uphill, differently depending on the surrounding scenery. For example, in a case where a structure such as a building is present near (around) the driver, the driver senses the degree of inclination of the uphill while using as references, lines of the structure in the vertical direction and lines thereof in the horizontal direction. In contrast, in a case where no structure is present near (around) the driver, because of a smaller number of elements serving as the references which allow the driver to sense, the inclination of the uphill, the driver may sense the inclination of the uphill to a lesser extent. Therefore, in a case where a structure is present around the vehicle, the driver may feel that the uphill has a larger inclination as con pared with a case where no structure is present around the vehicle.

For these reasons, in some cases, the driver feels that the hill hold control is started to be performed appropriately, and in other cases, the driver feels that the hill hold control is not started to be performed appropriately, even though the hill hold control is designed to be started to be performed on an uphill having the same climbing angle θ. Therefore., the conventional brake control apparatus may sometimes cause the driver to feel strangeness.

In view of the foregoing. In the present embodiment, the total value Ssum of the non-road surface areas is calculated on the basis of the front camera image. If the total value Ssum is greater than the structure index threshold value Sth, the brake activation threshold θth is set to be smaller (namely, the brake activation threshold θth is set to the first activation threshold θth1) as compared to a case where the total value Ssum is equal to or smaller than the structure index threshold value Sth. The total value Ssum (namely, the sum of the structure index values Sa, Sb, Sc, Sf, and Sg) is an index value which represents the degree of driver's easiness of estimating (sensing) the inclination of the uphill. In other words, the total value Ssum is a value indicative of how easily the driver can sense the inclination of the uphill. Therefore, when a structure is located near (around) the own vehicle (namely, when the total value Ssum is relatively high), the brake activation threshold θth is set to be smaller (namely, the brake activation threshold θth is set to the first activation threshold θth1). Accordingly, if the total value Ssum is relatively high, the hill hold control is performed even when the climbing angle θ is relatively small. Namely, in this case, the hill hold control is easier to be started to be performed. In contrast, when a structure is not present near (around) the own vehicle, the brake activation threshold θth is set to be relatively larger (namely, the brake activation threshold θth is set to the second activation threshold θth2. Therefore, the hill hold control is not performed unless the climbing angle θ is relatively large. In this manner, since the hill hold control is started to be performed in accordance with the degree of inclination of the uphill that the driver senses, the unnatural sensation given to the driver can be mitigated.

In addition, each of the structure index values Sa, Sb, Sc, Sf, and Sg is calculated on the basis of the vertical image element value Sx indicating a degree of vertical direction references that the driver can use to estimate (determine) the inclination of the uphill, and the horizontal image element value Sy indicating a degree of horizontal direction references that the driver can use to estimate (determine) the inclination of the uphill. Therefore, the total value Ssum, which is the total value of these index values, is a value which varies in accordance with the degree of inclination of the uphill that the driver senses. Accordingly, the brake activation threshold θth can be set appropriately.

Further, if the road index values for the road surface areas is equal to or less than the road index threshold value Rth, the brake activation threshold θth is set to be its maximum value (namely, the brake activation threshold θth is set to the third activation threshold θth3). The hill hold control is a kind of braking force control on the assumption that the own vehicle has stopped on a road (road surface). For this reason, when it is estimated that the own vehicle has stopped on a place other than a road, the brake activation threshold θth is set to be larger. As a result, in this case, the hill hold control is hard (less likely) to be performed.

### <Modification of Brake Activation Threshold Calculation Routine>

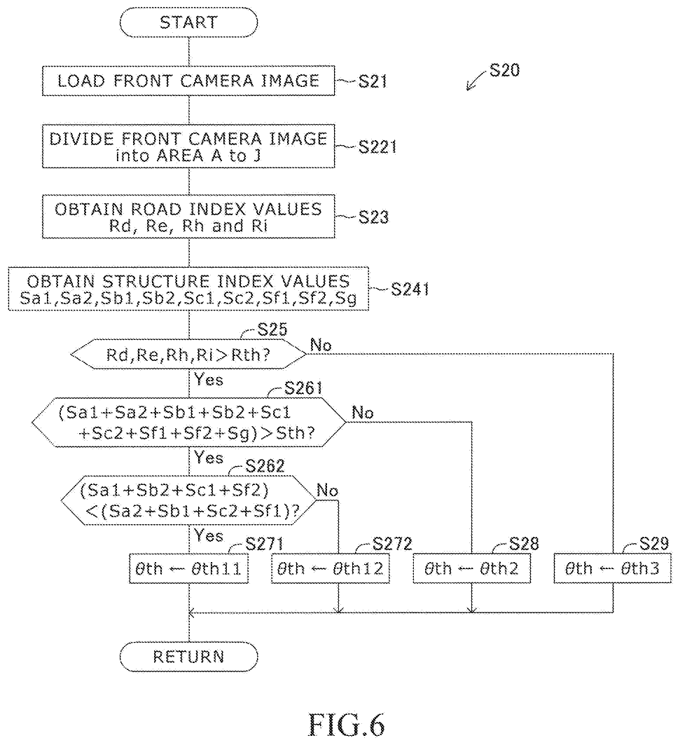

Next, a modification of the brake activation threshold calculation routine will be described. A flowchart shown in FIG. 6 represents the modification of the brake activation threshold calculation routine. In the present modification, the drive assistance ECU 10 executes the brake activation threshold calculation routine shown in FIG. 6 instead of the above-described routine shown in FIG. 3.

To simplify the description, each step shown in FIG. 6 at which the same processing is performed as each step shown in FIG. 3 is given the sa e step symbol as one given to such step shown in FIG. 3.

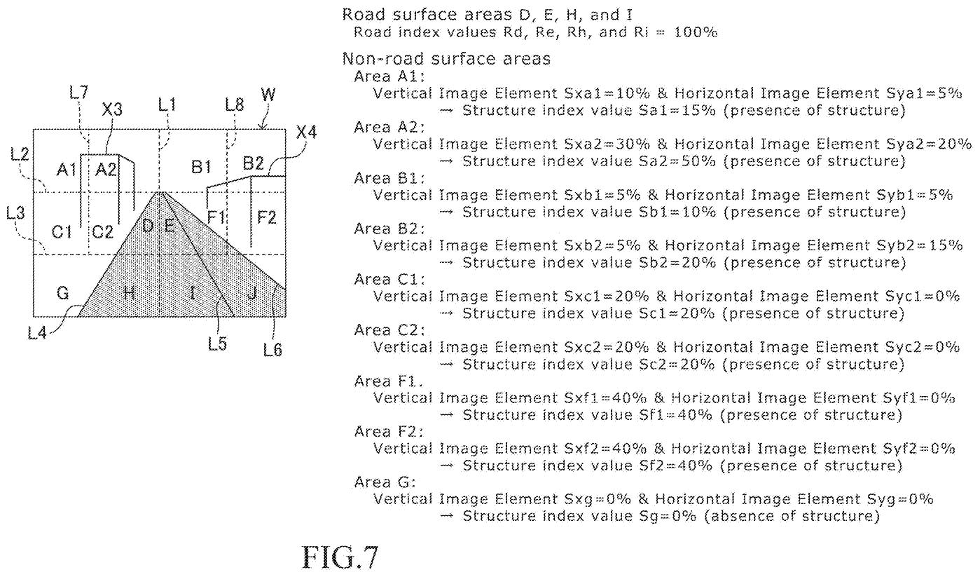

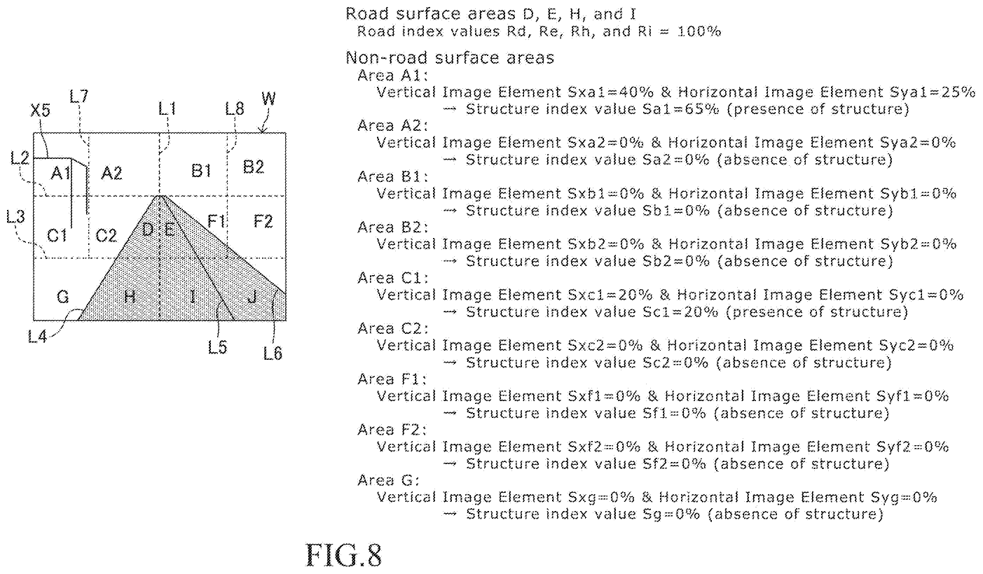

When the drive assistance ECU 10 according to the present modification starts the process of the brake activation threshold calculation routine, the drive assistance ECU 10 proceeds to step S21 so as to load a front camera image W. Subsequently, the drive assistance ECU 10 proceeds to step S221 so as to divide the front, camera image W into an area A to an area J. In the present modification, unlike the process of step S22 described above, each of the area A, the area B, the area C, and the area F is divided into two areas, as shown in FIG. 7 and FIG. 8. More specifically, the area A is divided by a division line L7 into an area A1 and an area A2. The division line L7 is a straight line extending in the vertical direction passing through the center in the horizontal direction of the area A. The area C is also divided by the division line L7 into an area C1 and an area C2. In addition, the area B is divided by a division line L8 into an area B1 and an area 132. The division line L8 is a straight line extending in the vertical direction passing through the center in the horizontal direction of the area B. The area F is also divided by the division line L7 into an area F1 and an area F2.

In an example of the front camera image W shown in FIG. 7, an image of a structure X3 extends so as to be present in the area A1, the area A2, the area C1, and the area C2. Namely, each of the area A1, the area A2, the area C1 and the area C2 partially overlaps with the structure X3. In addition, an image of a structure X4 extends so as to be present in the area B1, the area B2, the area F1, and the area F2. Namely, each of the area 31, the area B2, the area F1 and the area F2 partially overlaps with the structure X4. In another example of the front camera image W shown in FIG. 8, an image of a structure X5 extends so as to be present in the area A1, and the area C1. Namely, each of the area A1 and the area C1 of the front camera image W partially overlaps with the structure X5. The example shown in FIG. 8 represents an example in which a structure is far from the own vehicle as compared to the example shown in FIG. 7.

Subsequently, the drive assistance ECU 1 proceeds to step S23 so as to obtain (calculate) road index values Rd, Re, Rh, and Ri. Thereafter, the drive assistance ECU 10 proceeds to step S241 so as to obtain (calculate) structure index values Sa1, Sa2, Sb1, Sb2, Sc1, Sc2, Sf1, Sf2, and Sg respectively corresponding to the non-road surface areas A1, A2, B1, B2, C1, C2, F1, F2, and G. A method of obtaining these structure index values is similar to the method for obtaining the structure index values of the embodiment described above. Namely, each of the structure index values is obtained by getting a sum of the vertical image element value Sx and the horizontal image element value Sy.

In the example shown in FIG. 7, as for the area A1, since a vertical image element value Sxa1 and a horizontal image element value Sya1 are 10% and 5%, respectively, the structure ndex value Sa1 is 15%. As for the area A2, since a vertical image element value Sxa2 and a horizontal image element value Sya2 are 30% and 20%, respectively, the structure index value Sa2 is 50%. As for the area B1, since a vertical image element value Sxb1 and a horizontal image element value Syb1 are 5% and 5%, respectively, the structure index value Sb1 is 10%. As for the area B2, since a vertical image element value Sxb2 and a horizontal image element Syb2 value are 5% and 15%, respectively, the structure index value Sb2 is 20%. As for the area C1, since a vertical image element value Sxc1 and a horizontal image element value Syc1 are 20% and 0%, respectively, the structure index value Sc1 is 20%. As for the area C2, since a vertical image element value Sxc2 and a horizontal image element value Syc2 are 20% and 0%, respectively, the structure index value Sc2 is 20%. As for the area F1, since a vertical image element value Sxf1 and a horizontal image element value Syf1 are 40% and 0%, respectively, the structure index value Sf1 is 40%. As for the area F2, since a vertical image element value Sxf2 and a horizontal image element value Syl2 are 40% and 0%, respectively, the structure index value Sf2 is 40%. As for the area G, since a vertical image element value Sxg and a horizontal image element value Syg are 0% and 0%, respectively, the structure index value Sg is 0%.

In the example shown FIG. 8, as for the area A1, since a vertical image element value Sxa1 and a horizontal image element value Sya1 are 40% and 25%, respectively, the structure index value Sa1 is 65%. As for the area C1, since a vertical image element value Sxc1 and a horizontal image element value Syc1 are 20% and 0%, respectively, the structure index value Scl is 20%. As for the areas A2, B1, B2, C2, F1, F2, and G, since all of the vertical image element values Sx and the horizontal image element values Sy are 0%, respectively, each of the construction index values Sa2, Sb2, Sc2, Sf1, Sf2 and Sg is 0%.

Subsequently, the drive assistance ECU 10 proceeds to step S25 so as to determine whether or not each of the road index values Rd, Re, Rh, and Ri is greater than the road index threshold value Rth. When the drive assistance ECU 10 makes a “No” determination in step S25 (i.e., when at, least one of the road index values Rd, Re, Rh, and Ri is equal to or smaller than the threshold value Rth), the drive assistance ECU 10 proceeds to step S29 so as to set the brake activation threshold θth to the third activation threshold θth3.

Meanwhile, if each and every one of the road index values Rd, Re, Rh and Ri is greater than the road index threshold value Rth (S25: Yes) (namely, when there is a probability that a travelling region in front of the own vehicle is a road) the drive assistance ECU 10 proceeds to step S261.

In step S261, the drive assistance ECU 10 determines whether or not the total value Ssum is greater than the structure index threshold value Sth. In the present modification, the total value Ssum is equal to the sum of the structure index values Sa1, Sa2, Sb1, Sb2, Sc1, Sc2, Sf1, Sf2 and Sg (namely, Ssum=Sa1+Sa2+Sb1+Sb2+Sc1+Sc2+Sf1+Sf2+Sg).

If the total value Ssum is greater than the structure index threshold value Sth (S261: Yes) (namely, it is deduced (determined) that a structure is likely to be present in front of the own vehicle, the structure serving as the references for the driver to estimate the degree of inclination of the uphill), the drive assistance ECU 10 proceeds to step S262. In contrast, if the total value Ssum is equal to or smaller than the structure index threshold value Sth (S261: No) (namely, it is deduced (determined) that there is no such a structure in front of the own vehicle), the drive assistance ECU 10 proceeds to step S28 so as to set the brake activation threshold th to the second activation threshold θth2.

In step S262, the drive assistance ECU 10 determines whether or not a total value Ssum2 is greater than a total value Ssum1. The total value Ssum1 is equal to the sum of the structure index values Sa1, Sb2, Sc1, and Sf2 (namely, Ssum1=Sa1+Sb2+Sc1+Sf2) corresponding to the areas A1, B2, C1, and F2, respectively. Those areas A1, B2, C1, and F2 are areas relatively farther from the uphill in the horizontal direction and are referred to as “farther areas.” The total value Ssum2 is equal to the sum of the structure index values Sa2, Sb1, Sc2, and Sf1 (namely, Ssum2=Sa2+Sb1+Sc2+Sf1) corresponding to the areas A2, B1, C2, and F1, respectively. Those areas A2, B1, C2, and F1 are areas relatively closer to the uphill in the horizontal direction (as compared with the areas A1, B2, C1, and F2). The areas A2, B1, C2, and F1 are referred to as “nearer areas.”

When there are more structures in the nearer areas than the farther areas as shown in FIG. 7, the drive assistance ECU 10 makes a “Yes” determination in step S262. In contrast, when there are more structures in the farther areas than the nearer areas as shown in FIG. 8, the drive assistance ECU 10 makes a “No” determination in step S262.

When the drive assistance ECU 10 makes a “Yes” determination in step in S262, the drive assistance ECU 10 proceeds to step S271 so as to set the brake activation threshold θth to a predetermined first small activation threshold θth11. Meanwhile, the drive assistance ECU 10 makes a “No” determination in step in S262, the drive assistance ECU 10 proceeds to step S272 so as to set the brake activation threshold θth to a predetermined first medium activation threshold θth12.

The first medium activation threshold θth12 is smaller than the second activation threshold θth2, the first small activation threshold θth11 is smaller than the first medium activation threshold θth12 (namely, θth11<θth12<θth2<θth3).

When the drive assistance ECU 10 completes processing in step S271, step S272, step S28 or step S29, the drive assistance ECU 10 ends the brake activation threshold calculation routine and proceeds to step S30 of FIG. 2.

The shorter the distance from the driver to a structure present in the field of view of the driver is, the greater the degree of inclination of the uphill that the driver senses is. Therefore, when the sum of the structure index values of the nearer areas is greater than the sum of the structure index values of the farther areas, the brake activation threshold θth is set to the first small activation threshold θth11 which is the minimum vale of the brake activation threshold θth. In contrast, when the sum of the structure index values of the nearer areas is smaller than the sum of the structure index values of the farther areas, the brake activation threshold θth is set to the first medium activation threshold θth12 which is greater than the first small activation threshold θth11.

Accordingly, the brake activation threshold θth is set in accordance with the degree of inclination of the uphill that the driver senses. Therefore, the present modification can execute the hill hold control in various situations while mitigating (reducing) the possibility that the driver feels strangeness regarding the hill hold control, since the brake activation threshold θth is set more appropriately.

The embodiment and its modification of the vehicle brake control apparatus according to the present disclosure have been described, however, the present disclosure is not limited to the above-described embodiment (including the modification), and various modifications are possible without departing from the scope of the disclosure.

For example, in the present embodiment, when the drive assistance ECU 10 determines at least one of the road index values Rd, Re, Rh, and Ri is equal to or smaller than the road index threshold value Rth (S25: No), the drive assistance ECU 10 sets the brake activation threshold θth to the third activation threshold θth3. However, this process may be omitted. Namely, the processes of step S23, step S25 and step S29 may be omitted.

In addition, in the present embodiment, the brake actuator 21 is controlled so as to generate brake force of the own vehicle for the hill hold control. Alternatively, if the own vehicle is equipped with an electrical parking brake apparatus, the drive assistance ECU 10 may be configured to control the electrical parking brake apparatus so as to generate brake force of the own vehicle for the hill hold control.

In addition, in the present embodiment, the drive assistance ECU 10 obtains the structure index values on the basis of an image photographed by the front camera of the camera sensors 11. However, the drive assistance ECU 10 may be configured to obtain the structure index values on the basis of an image photographed by the rear camera of the camera sensors 11, because the condition (scene) regarding structures behind the own vehicle is similar to that in front of the own vehicle in many cases.

In addition, in the present embodiment, the longitudinal acceleration sensor is utilized to estimate the climbing angle θ. However, a sensor other than the longitudinal acceleration sensor (for example, a dedicated tilt angle sensor which is installed in the own vehicle) may be utilized to estimate a climbing angle θ.

In addition, in the present embodiment, the drive assistance ECU 10 sets (changes) the brake activation threshold θth in accordance with the vertical image element values Sx and the horizontal image element values Sy. However, the drive assistance ECU 10 may be configured to set (change) the climbing angle θ instead of the brake activation threshold θth in accordance with the vertical image element values Sx and the horizontal image element values Sy.

What is claimed is:

1. A brake control apparatus for a vehicle comprising:
a hill hold control section for performing hill hold control, when an execution condition of said hill hold control is satisfied, said execution condition being a condition to be satisfied when an uphill on which said vehicle has stopped has an inclination greater than a brake activation threshold, said hill hold control being a control to activate a brake apparatus, without requiring any braking operation of a driver, to thereby prevent said vehicle from moving backward on said uphill;
a structure detection section for detecting a structure around'said vehicle; and
an execution condition changing section for changing said execution condition of said hill hold control such that said hill hold control is more easily to be started in a case where said structure is detected around said vehicle as compared with a case where said structure is not detected.

2. The brake control apparatus for a vehicle according to claim 1, wherein said execution condition changing section is configured to change said execution condition of said hill hold control such that said hill hold control is more easily to be started when said structure detected around said vehicle is located near said vehicle, as compared with when said structure is located away from said vehicle.

3. The brake control apparatus for a vehicle according to claim 1, wherein said execution condition changing section is configured to decrease said brake activation threshold to let said hill hold control be started more easily.

4. The brake control apparatus for a vehicle according to claim 3, wherein
said structure detection section is configured to recognize said structure on the basis of a camera image obtained by photographing an area ahead of said vehicle using a camera, and
said execution condition changing section is configured to:
extract, from said camera image, a vertical image element vertically extending and a horizontal image element horizontally extending, said vertical image element and said horizontal image element corresponding to an image of a structure in said camera image,
calculate a structure index value in such a manner that said structure index value increases as a ratio increases, said ratio being, a ratio of said vertical image element and said horizontal image element to said camera image; and
determine said brake activation threshold on the basis of said structure index value.

5. The brake control apparatus for a vehicle according to claim 4, wherein
said execution condition changing sect on is configured to:
determine whether or not said structure index value is greater than a previously set structure index threshold; and
set said brake activation threshold, when said structure index value is greater than said structure index threshold, to a value which is smaller than a value set when said structure index value is equal to or smaller than said structure index threshold.

6. The brake control apparatus for a vehicle according, to claim 4, wherein
said execution condition changing section is configured to
calculate said structure index value in a region located close to said uphill and said structure index value in a region located away from said uphill; and
set said brake activation threshold, when said structure index value in the region located close to said uphill is greater than said structure index value in the region located away from said uphill, to a value which is smaller than a value set when said structure index value in the region located close to said uphill is smaller than said structure index value in the region located'away from said uphill.

7. The brake control apparatus for a vehicle according to claim wherein
said execution condition changing section is configured to
calculate said structure index value in a region located close to said uphill and said structure index value in a region located away from said uphill; and
set said brake activation threshold, when said structure index value in the region located close to said uphill is greater than said structure index value in the region located away from said uphill, to a value which is smaller than a value set when said structure index value in the region located close to said uphill is smaller than said structure index value in the region located away from said uphill.

8. The brake control apparatus for a vehicle according to claim 2, wherein said execution condition changing section is configured to decrease said brake activation threshold to let said hill hold control be started more easily.

9. The brake control apparatus for a vehicle according to claim 8, wherein
said structure detection section is configured to recognize said structure on the basis of a camera image obtained by photographing an area ahead of said vehicle using a camera, and
said execution condition changing section is configured to:
extract, from said camera image, a vertical image element vertically extending and a horizontal image element horizontally extending, said vertical image element and said horizontal image element corresponding to an image of a structure in said camera image;
calculate a structure index value in such a manner that said structure index value increases as a ratio increases, said ratio being a ratio of said vertical image element and said horizontal image element to said camera image and
determine said brake activation threshold on the basis of said structure index value.

10. The brake control apparatus for a vehicle according to claim 9, wherein
said execution condition changing section is configured to:
determine whether or not said structure index value is greater than a previously set structure index threshold; and
set said brake activation threshold, when said structure index value is greater than said structure index threshold, to a value which is smaller than a value set when said structure index value is equal to or smaller than said structure index threshold.

11. The brake control apparatus for a vehicle according to claim 9, wherein
said execution condition changing section is configured to
calculate said structure index value in a region located close to said uphill and said structure index value in a region located away from said uphill; and
set said brake activation threshold, when said structure index value in the region located close to said uphill is greater than said structure index value in the region located away from said uphill, to a value which is smaller than a value set when said structure index value in the region located close to said uphill is smaller than said structure index value in the region located away from said uphill.

12. The brake control apparatus for a vehicle according to claim 10, wherein
said execution condition changing section is configured to :
calculate said structure index value in a region located close to said uphill and said structure index value in a region located away from said uphill; and
set said brake activation threshold, when said structure index value in the region located dose to said uphill is greater than said structure index value in the region located away from said uphill, to a value which is smaller than a value set when said structure index value in the region located close to said uphill is smaller than said structure index value in the region located away from said uphill.
